(19) United States
(12) Patent Application Publication
(10) Pub. No.: US 2023/0335321 A1
(43) Pub. Date: Oct. 19, 2023

(54) MAGNETIC CORE MATERIAL AND MAGNETIC CORE

(71) Applicant: NTN Corporation, Osaka (JP)

(72) Inventors: Shinya AMANO, Aichi (JP); Noritaka KAKO, Aichi (JP); Eiichirou SHIMAZU, Aichi (JP)

(21) Appl. No.: 18/027,208

(22) PCT Filed: Sep. 6, 2021
(86) PCT No.: PCT/JP2021/032646

§ 371 Date: Mar. 20, 2023

(30) Foreign Application Priority Data
Sep. 30, 2020 (JP) 2020-165712
Jun. 7, 2021 (JP) 2021-095071

(51) Int. Cl. H01F 1/26; H01F 27/255

(52) U.S. Cl. CPC H01F 1/26; H01F 27/255; H05B 6/02

(57) ABSTRACT

A magnetic core material contains an Fe-based soft magnetic powder in which an inorganic insulating film 4b is formed on a surface of an Fe-based soft magnetic particle 4a, and an epoxy resin 4c containing a curing agent. The Fe-based soft magnetic particle 4a is formed of a pure iron powder or a low-alloy steel powder. A content of the epoxy resin containing the curing agent is 2 to 5 mass %. The epoxy resin is a mixture of a bisphenol A-type epoxy resin and a novolac-type epoxy resin.

### TECHNICAL FIELD

The present invention relates to a magnetic core material and a magnetic core.

### BACKGROUND ART

A magnetic core attached to a heating coil part of an induction hardening apparatus has an effect that the magnetic core attached to a back face of the coil concentrates magnetic force lines on a workpiece to enhance power so as to accelerate induction heating and an effect that the magnetic core attached conversely to a front face of the coil to shield magnetic lines to prevent heating of a part requiring no hardening; therefore, the magnetic core is a component indispensable for a heating coil of an induction hardening apparatus. A powder magnetic core produced by a powder metallurgy method has little raw material loss and is excellent in mass productivity; therefore, the magnetic core produced by the powder metallurgy method is often used as a magnetic core used for a heating coil of an induction hardening apparatus.

As a magnetic core used for an induction hardening apparatus, Patent Literature 1 discloses a magnetic core produced as follows. A mixture is prepared by mixing 97 wt % of iron powder particles whose particle surfaces are covered with an inorganic-based insulating film and 3 wt % of epoxy resin powder containing dicyandiamide as a curing agent. Particles that pass through a sieve with a sieve mesh size of 106 μm but do not pass through a sieve with a sieve mesh size of 25 μm are taken out. The taken-out particles are heat-kneaded at a temperature of 110° C. for 15 minutes and compression-molded under a pressure of 200 MPa, and are heated at a temperature of 180° C. for 1 hour in a nitrogen atmosphere to cure the epoxy resin.

### CITATIONS LIST

### Patent Literature

Patent Literature 1: WO 2016/043295 A

### SUMMARY OF INVENTION

### Technical Problems

A magnetic core of a powder magnetic core type for an induction heating apparatus is used in a high frequency range, for example, a power supply frequency of about 10 kHz to 500 kHz. It is necessary to select an appropriate frequency and relative permeability of the magnetic core in accordance with a desired hardening depth. For example, at high frequencies of 100 kHz or higher, depending on the hardening depth, the core to be used is often required to have a relative permeability of less than 25, particularly, a relative permeability of about 20.

In the case of a general powder magnetic core containing no resin binder, in order to suppress the relative permeability to less than 25, it is necessary to extremely lower the molding pressure so as to mold a powder magnetic core having a low density. However, it is practically difficult to achieve a relative permeability less than 25 within a moldable range, and even if molding is successfully performed, there are many pores inside, which are structural defects; therefore, there arises a problem of insufficient strength when the core is used as a core for induction hardening. In addition, the volume resistivity is lower; therefore, there also arises a problem that the eddy-current loss is accordingly higher and there will be caused an increase in loss and deterioration of frequency characteristics in a high frequency range.

The magnetic core used for induction hardening may be heated to a high temperature in some conditions of use. When the magnetic core is used at high temperatures, a lifetime of the magnetic core is shorter; therefore, it is preferable to design such that the core temperature stays as low as possible. The cause of the high temperature is mainly radiant heat from the workpiece being hardened and heat generation due to iron loss of the magnetic core itself. The heat generation of the magnetic core itself can be reduced by selecting the material of the iron powder particles.

In addition, it was found that in a powder magnetic core using a resin binder as in Patent Literature 1, depending on the type of the resin binder, the resin binder is sometimes ejected (blow-off) on the surface during thermal curing of the resin. When the resin is ejected as described above, a molded body is adhered to a plate and the like for aligning molded bodies in a heating furnace for thermal curing, which causes a decrease in productivity.

The present invention has been made to address such problems, and an object of the present invention is to provide a magnetic core material that can obtain a magnetic core having excellent frequency characteristics and satisfying required strength and volume resistivity while having low permeability and that can prevent or reduce blow-off of resin during thermal curing.

### Solutions to Problems

A magnetic core material according to the present invention includes: an Fe-based soft magnetic powder in which an inorganic insulating film is provided on surfaces of Fe-based soft magnetic particles; and an epoxy resin material, wherein the epoxy resin material includes a curing agent and an epoxy resin, the Fe-based soft magnetic particles are a pure iron powder or a low-alloy steel powder, a content of the epoxy resin material is 2 mass % or more and 5 mass % or less, and the epoxy resin includes a bisphenol A-type epoxy resin and a novolac-type epoxy resin.

A magnetic core using the magnetic core material described above can provide a magnetic core that has low permeability, and at the same time, that can provide excellent frequency characteristics and can satisfy required radial crushing strength and volume resistivity.

In a case where a low-alloy steel powder is used as the Fe-based soft magnetic particles, the low-alloy steel powder preferably includes one or both of Si and Cr as an alloy component, and a total content of the alloy component in the low-alloy steel powder is preferably 6.5 mass % or less. As a result, it possible to achieve low permeability.

In a case where a pure iron powder is used as the Fe-based soft magnetic particles, a content of the epoxy resin material is preferably 3 mass % or more and 5 mass % or less.

The Fe-based soft magnetic powder preferably has a median diameter D50 of 10 μm or more and 70 μm or less. As a result, iron loss in the magnetic core can be reduced, and heat generation of the magnetic core itself can be reduced.

A magnetic core can be formed by curing the epoxy resin of the magnetic core material described above.

The magnetic core preferably has a relative permeability of 17 to 25.

The magnetic core preferably has a radial crushing strength of 50 MPa or more. The magnetic core preferably has a volume resistivity of 1×10⁴ Ωcm or more.

An inductance retention rate of the magnetic core at 1,000 kHz with respect to 5 kHz is preferably 80% or more.

By combining the above magnetic core with a coil, it is possible to provide an induction heating apparatus including a magnetic core that has high strength, a high degree of freedom in selection of a hardening depth, and a small loss even in a high frequency region.

### Advantageous Effects of Invention

The present invention makes it possible to provide a magnetic core material that can obtain a magnetic core having excellent frequency characteristics and satisfying required strength and volume resistivity while having low permeability and that can prevent or reduce blow-off of resin during thermal curing.

### BRIEF DESCRIPTION OF DRAWINGS

FIG. 1 is a diagram illustrating a schematic positional relationship between a magnetic core and a coil, in an induction hardening apparatus.

FIG. 2 is a diagram illustrating a schematic positional relationship between a magnetic core and a coil, in an induction hardening apparatus.

FIG. 3 is a sectional view of a particle of a composite soft magnetic powder.

FIG. 4 is a table showing evaluation test results.

FIG. 5 is a table showing evaluation test results.

FIG. 6 is a table showing evaluation test results.

FIG. 7 is a table showing evaluation test results.

### DESCRIPTION OF EMBODIMENT

Hereinafter, there will be described an embodiment of a magnetic core material and a magnetic core according to the present invention.

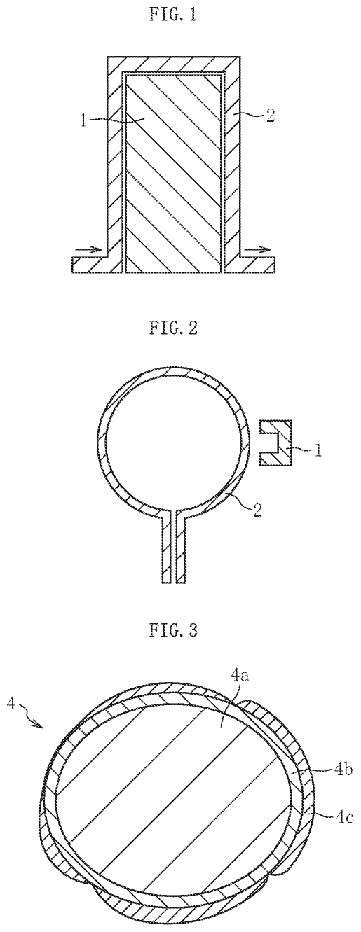

FIGS. 1 and 2 illustrate a positional relationship between a magnetic core and a coil disposed in an induction heating apparatus such as an induction hardening apparatus. As illustrated in FIGS. 1 and 2, the coil 2 includes a pipe, a plate, or the like made of a conductive metal material such as copper. In order to improve a heating efficiency or to adjust a part to be heated, a magnetic core 1 that controls magnetic flux is disposed close to the coil 2. The magnetic core 1 can change a state of induction heating by concentrating magnetic flux generated by a current flowing through the coil 2, on a workpiece or conversely by shielding the magnetic flux. FIG. 1 is a view illustrating a form in which the magnetic core 1 is fitted inside the coil 2 and used, and FIG. 2 is a view illustrating a form in which the magnetic core 1 is disposed in a partial region, outside the coil 2, in a winding direction and used. As described above, the magnetic core 1 is disposed inside or outside the coil 2 in combination with the coil 2.

The magnetic core 1 is obtained by compression-molding a magnetic core material made of a composite soft magnetic powder containing a resin powder and an Fe-based soft magnetic powder, and then curing the resin by heating. As illustrated in FIG. 3, a particle 4 of the composite soft magnetic powder has the following structure. An inorganic insulating film 4b is formed on a surface of an Fe-based soft magnetic particle 4a, and an uncured resin film 4c is further formed on a surface of the inorganic insulating film 4b. The magnetic core 1 is produced by compression-molding the composite soft magnetic powder 4 together with a solid lubricant, and then thermally curing the resin film 4c. Thereafter, post-processing such as cutting, barrel processing, and a rust prevention treatment is performed as necessary. The shape and the like of the magnetic core 1 to be disposed can be appropriately changed depending on a shape, size, location, and the like of a high frequency coil.

As the Fe-based soft magnetic particle 4a, pure iron powders are preferable, and among them, an atomized iron powder is preferable, and a water-atomized iron powder is particularly preferable. The water-atomized iron powder is an iron powder produced by powdering and cooling molten steel with high-pressure water and then heat-treating the steel in a hydrogen atmosphere, and the water-atomized iron powder has a feature that the particles are solid having no pores inside the particles and have a substantially spherical shape. As the iron powder, in addition to the atomized iron powder, a reduced iron powder is also known, but the reduced iron powder has a porous shape having a large number of pores and has a large number of irregularities on the surface. Because each particle of the atomized iron powder has a spherical shape, the particle has a smaller specific surface area than the reduced iron powder. As a result, the relative permeability of the magnetic core 1 can be made small. In addition, because the thickness of the resin binder among the magnetic powder is larger, it is possible to improve insulation and thereby to increase the volume resistivity. Furthermore, since corrosion resistance is larger due to the thicker resin binder, the magnetic core is preferably used as a magnetic core for an induction hardening apparatus used in an environment where cooling water is directly splashes on the magnetic core.

Besides the pure iron powder used as the Fe-based soft magnetic particles 4a, it is possible to use the low-alloy steel powder such as an iron-silicon-based alloy, an iron-chromium-based alloy, an iron-silicon-chromium-based alloy, an iron-nitrogen-based alloy, an iron-nickel-based alloy, an iron-carbon-based alloy, an iron-boron-based alloy, an iron-cobalt-based alloy, an iron-phosphorus-based alloy, an iron-nickel-cobalt-based alloy, or an iron-aluminum-silicon-based alloy (sendust alloy). Also in this case, the Fe-based soft magnetic particles 4a are preferably formed of an atomized steel powder (particularly, water-atomized steel powder).

As an alloy component of these low-alloy steel powders, it is preferable to use either one or both of Si and Cr. The low-alloy steel powder contains one or both of Si and Cr, and the rest of the components includes iron and unavoidable impurities. In addition, the total content of the alloy component in the low-alloy steel powder is preferably 6.5 mass % or less. When the content of the alloy component is excessively large, compressibility is lowered, required magnetic properties cannot be secured, and workability is also lowered. For example, it is possible to use Fe4.5Si as the Fe—Si-based alloy, Fe2Cr as the Fe—Cr-based alloy, and Fe4.5Si2Cr as the Fe—Si—Cr-based alloy.

The entire surface of the Fe-based soft magnetic particle 4a is covered with an inorganic insulating film 4b. As a material of the inorganic insulating film 4b, it is preferable to use a metal phosphate such as iron phosphate, manganese phosphate, zinc phosphate, calcium phosphate, or aluminum phosphate. In addition, various silane coupling agents may be used. The inorganic insulating film 4b may be formed of one type of material or two or more types of materials. Examples of commercially available products of the Fe-based soft magnetic powder in which the surfaces of the Fe-based soft magnetic particles 4a are covered with the inorganic insulating film 4b include Somaloy (trade name) manufactured by Heganes Corporation.

As the Fe-based soft magnetic powder, it is preferable, from the viewpoint of reducing heat generation in the core itself, to use an Fe-based soft magnetic powder having a median diameter D50 (particle diameter at which a number-based cumulative frequency is 50%) of 10 μm or more and 70 μm or less. When the particle diameter of the Fe-based soft magnetic powder is excessively small, it is difficult to form the resin film 4c on the surface thereof. In addition, when the particle size is excessively large, the iron loss is larger. In particular, when a pure iron powder is used as the Fe-based soft magnetic particles 4a, the median diameter D50 is preferably 40 μm or more and 70 μm or less, and when a low-alloy steel powder is used as the Fe-based soft magnetic particles 4a, the median diameter D50 is preferably 10 μm or more and 30 μm or less.

As a material of the resin film 4c, an epoxy resin material including an epoxy resin and a curing agent is used. The epoxy resin is obtained by mixing a bisphenol A-type epoxy resin and a novolac-type epoxy resin. The novolac-type epoxy resin has three or more of functional groups per molecule, and has a property of easily crosslinking three-dimensionally as compared with the bisphenol A-type epoxy resin, which has two functional groups per molecule. When only a bisphenol A-type epoxy resin is used as the epoxy resin, there is a problem that the shape of the molded body cannot be maintained since an epoxy resin material is blown off from the inside to the surface of the molded body during thermal curing as described later. The epoxy resin material is a thermosetting resin in which, by heating a combination of a main agent and a curing agent, reaction proceeds and the epoxy resin material is therefore cured. However, when the epoxy resin material is heated to a high temperature, a viscosity of a part that has not reacted yet decreases, so that the fluidity is increased and the epoxy resin material is easily blown off. By adding a novolac-type epoxy resin to the bisphenol A-type epoxy resin, the viscosity of the epoxy resin is increased, so that it is possible to prevent blow-off of the epoxy resin during thermal curing. As the epoxy resin obtained by mixing a bisphenol A-type epoxy resin and a novolac-type epoxy resin, “Epiform EPX-6136” available from Somar Co., Ltd. can be used, for example.

Note that, when only the novolac-type epoxy resin is used, the strength of the molded body after thermal curing may be insufficient. Because a magnetic core to be disposed in an induction heating apparatus such as an induction hardening apparatus is worked in accordance with the shape of a workpiece or a coil, the magnetic core needs to have strength that can withstand the working.

As a component of the curing agent, a latent epoxy curing agent is used. By using the latent epoxy curing agent, the softening temperature can be set to 100 to 120° C. and the curing temperature can be set to 170 to 200° C., so that it is possible to form an organic insulating coating film (resin film 4c) on each particle of the Fe-based soft magnetic powder and to subsequently perform compression molding and thermal curing. Examples of the latent epoxy curing agent include dicyandiamide, a boron trifluoride-amine complex, and an organic acid hydrazide. Among these agents, it is preferable to use dicyandiamide, which is suitable for the above effect conditions. A curing accelerator such as a tertiary amine, imidazole, an aromatic amine, or the like can be included together with the latent epoxy curing agent.

The amount of the latent curing agent contained in the epoxy resin material is determined depending on the heating temperature and the heating time. For example, the amount of the latent curing agent is selected such that the epoxy resin is cured by heating at a heating temperature of 200° C. for 1 hour.

It is preferable that the blending amount of the epoxy resin material (including the curing agent) in the magnetic core material to be used as a raw material for the magnetic core be 2 mass % or more and 5 mass % or less and that the rest of the components be the Fe-based soft magnetic powder, the inorganic insulating film, and the solid lubricant. When the content of the epoxy resin material is less than 2 mass %, it is difficult to form an effective insulating film, and in addition, the strength is lowered. When the content of the epoxy resin material is more than 5 mass %, magnetic properties are deteriorated, and resin-rich coarse agglomerates are generated. The blending amount of the solid lubricant is preferably about 0.5 mass % to 1 mass %. As the solid lubricant, 0.5 mass % of Kenolube manufactured by Heganes Corporation can be blended, for example. In addition, as the solid lubricant, a metal soap-based agent or a fatty acid amide-based agent may be used.

In a case where a pure iron powder is used as the Fe-based soft magnetic particles 4a, the blending amount of the epoxy resin material is preferably 3 mass % or more and 5 mass % or less. Alternatively, in a case where a low-alloy steel powder is used as the Fe-based soft magnetic particles 4a, the blending amount of the epoxy resin material is preferably 2 mass % or more and 5 mass % or less.

In a production process of the magnetic core according to the present embodiment, the Fe-based soft magnetic powder and epoxy resin material described above are dry-mixed at a temperature of 100 to 120° C. to form the uncured resin films 4c on the inorganic insulating films 4b covering the surfaces of Fe-based soft magnetic body particles 4a. This uncured resin film is also an insulating film, and after thermal curing, a composite insulating film including an inorganic insulating film and a resin film is formed on the surfaces of the Fe-based soft magnetic particles 4a. This composite insulating film remarkably improves insulation of the film, thereby, obtaining high electric insulation. The raw material (magnetic core material) described above is supplied to a mold, and a molded body is formed by compression molding. After that, the molded body is thermally cured at a temperature equal to or higher than a thermal curing start temperature of the epoxy resin material, whereby the magnetic core 1 in one body is obtained.

A method for manufacturing the above magnetic core will be specifically described.

An epoxy resin material having been blended with the above-described Fe-based soft magnetic powder and the epoxy resin material having been blended with the above-described latent curing agent are each prepared. The Fe-based soft magnetic powder is prepared in advance through a classifier to satisfy D50=10 to 70 μm.

Next, in a mixing step, the Fe-based soft magnetic powder and the epoxy resin material are dry-mixed together with a solid lubricant at a temperature equal to or higher than the softening temperature of the epoxy resin and lower than the thermal curing start temperature. In the mixing step, first, the Fe-based soft magnetic powder and the epoxy resin material are sufficiently mixed at room temperature using a blender or the like. Next, the mixed mixture is put into a mixer such as a kneader and is heated and mixed at the softening temperature (100 to 120° C.) of the epoxy resin material. In this step of heating and mixing, the insulating film 4c (see FIG. 3) made of the epoxy resin material is formed on the surface of each particle of the Fe-based soft magnetic powder. At this stage, the epoxy resin material is not yet cured.

The contents heated and mixed using a mixer such as a kneader are in the form of agglomerated cake. A pulverizing step is a step of obtaining a composite soft magnetic powder in which an insulating film of the epoxy resin material is formed on the surfaces, by pulverizing and sieving the agglomerated cake at room temperature. The pulverization is preferably performed with a Henschel mixer, and the sieving is preferably performed to get particles that pass through a sieve of 60 mesh (250 μm).

The mold used in the compression molding step is only required to be a mold capable of applying a molding pressure of 85 to 294 MPa. If the molding pressure is less than 85 MPa, the magnetic properties and the strength are low, and if the molding pressure exceeds 294 MPa, there arise problems such as adhering of the epoxy resin to the inner wall of the mold and deterioration of insulation due to breakage of the resin film. The molding pressure in the case of using a pure iron powder as the Fe-based soft magnetic particles 4a is preferably 85 MPa or more and 150 MPa or less, and the molding pressure in the case of using low-alloy steel powder as the Fe-based soft magnetic particles 4a is preferably 98 MPa or more and 245 MPa or less.

A molded article taken out from the mold is thermally cured at a temperature of 170 to 200° C. for 45 to 80 minutes. This is because curing takes a long time at a temperature lower than 170° C., and deterioration starts at a temperature higher than 200° C. The thermal curing is preferably performed in a nitrogen atmosphere, but may be performed in an atmosphere containing oxygen such as air. After the thermal curing, cutting, barrel processing, a rust prevention treatment, and the like are performed as necessary, whereby the magnetic core 1 illustrated in FIGS. 1 and 2 is obtained.

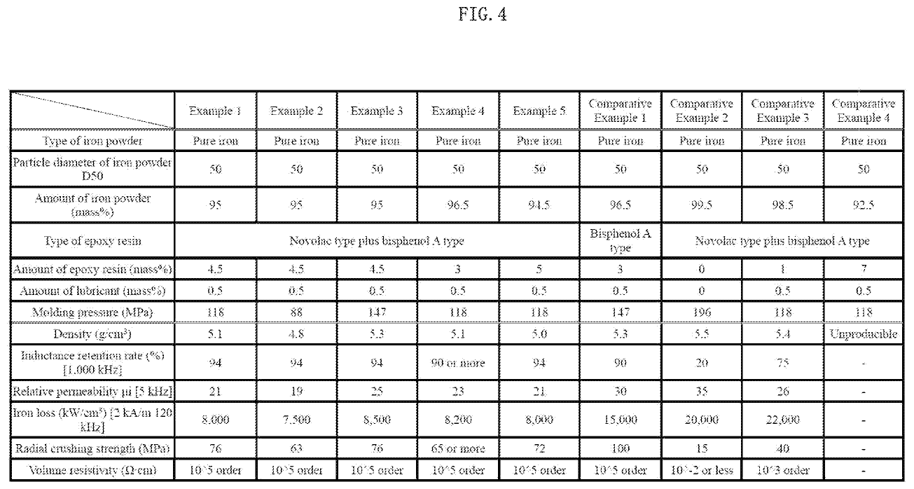

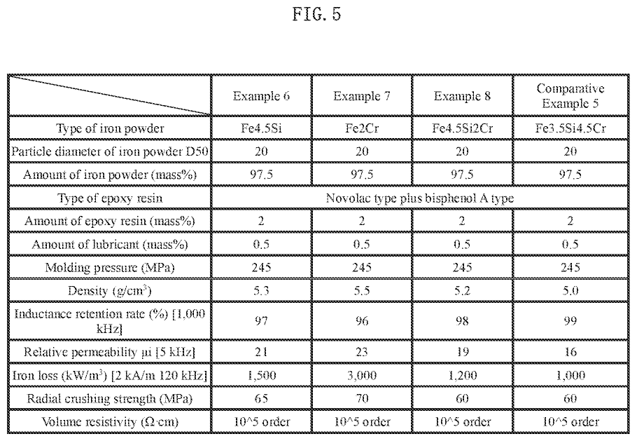

Hereinafter, an evaluation test conducted to evaluate the characteristics of the magnetic core 1 described above will be described, and the results thereof will be described with reference to FIGS. 4 to 7. Note that in Examples 1 to 5 and Comparative Example 1 to 4, test pieces using a pure iron powder as the Fe-based soft magnetic particles 4a were used (see FIG. 4), and in Examples 6 to 8 and Comparative Example 5, test pieces using a low-alloy steel powder as the Fe-based soft magnetic particles 4a were used (see FIG. 5). In addition, the amount of epoxy resin contained in the test pieces was different between Example 1, Example 4, Example 5, and Comparative Examples 2 to 4 (see FIG. 4). The type of the epoxy resin was different between Examples 1 to 5 and Comparative Example 1, and the molding pressure was different between Examples 1 to 3 (see FIG. 4). Furthermore, the type and amount of the alloy component contained in the Fe-based soft magnetic particles 4a were different between the test pieces of Examples 6 to 8 and Comparative Example 5 (see FIG. 5). In FIGS. 4 and 5, the Fe-based soft magnetic particles 4a (pure iron powder and low-alloy steel powder) are each referred to as “iron powder”.

### Example 1

The test piece of Example 1 is produced by the following procedure.
(1) The following materials are mixed with a rocking mixer at room temperature for 10 minutes: 95 mass % of a water-atomized pure iron powder coated with a phosphate film; 4.5 mass % of an epoxy resin material in which dicyandiamide as a curing agent is added to a bisphenol A-type epoxy resin and a novolac-type epoxy resin; and 0.5 mass % of Kenolube (manufactured by Heganes Corporation), which is a wax-based lubricant, as a solid lubricant. As the water-atomized iron powder, one having a particle diameter the value of whose number-based D50 is within the range of 40 to 70 μm is used.
(2) The mixture is put into a kneader and is heat-kneaded at a heater temperature of 100° C. for 10 minutes using both normal pressure kneading and pressure kneading.
(3) After the mixture is put into the kneader, an agglomerated cake obtained by the kneading is crushed and is then pulverized by a pulverizer.
(4) After the pulverization, particles that pass through a sieve with a mesh size of 30 (500 μm) in conformity with JIS Z 8801-1 (2006) are used as a compound powder (raw material powder).
(5) Next, the raw material powder is compression molded by using a mold, at a molding pressure of 118 MPa.
(6) The compression-molded article is taken out from the mold and is heated at a temperature of 200° C. in the air atmosphere for 1 hour to cure the epoxy resin, thereby producing a toroidal-shaped magnetic core.

### Example 2

The test piece of Example 2 was manufactured under the same conditions as in Example 1 except that only the molding pressure condition was changed to 88 MPa.

### Example 3

The test piece of Example 3 was manufactured under the same conditions as in Example 1 except that only the molding pressure condition was changed to 147 MPa.

### Example 4

In Example 4, with respect to Example 1, the amount of iron powder was changed to 96.5 mass %, and the amount of resin was changed to 3 mass %.

### Example 5

In Example 5, with respect to Example 1, the amount of iron powder was changed to 94.5 mass %, and the amount of resin was changed to 5 mass %.

### Example 6

In Example 6, with respect to Example 1, the iron powder was changed to Fe4.5Si, the insulating film was changed to a silane coupling agent, and the resin amount was changed to 2 mass %. In addition, the particle diameter of the iron powder was changed to satisfy D50=20 μm.

### Example 7

In Example 7, with respect to Example 6, the iron powder was changed to Fe2Cr.

### Example 8

In Example 8, with respect to Example 6, the iron powder was changed to Fe4.5Si2Cr.

### Comparative Example 1

In Comparative Example 1, with respect to Example 4, the epoxy resin was changed such that only a bisphenol A-type epoxy resin was used as the epoxy resin. In addition, the kneading conditions were changed to 110° C. for 15 minutes, and the molding pressure was changed to 147 MPa.

### Comparative Example 2

In Comparative Example 2, with respect to Example 1, the amount of iron powder was changed to 99.5 mass % without blending the epoxy resin, and the molding pressure was changed to 196 MPa.

### Comparative Example 3

In Comparative Example 3, with respect to Example 1, the amount of the iron powder was changed to 98.5 mass %, and the amount of the epoxy resin was changed to 1.0 mass %.

### Comparative Example 4

In Comparative Example 4, with respect to Example 1, the amount of the iron powder was changed to 92.5 mass %, and the amount of the epoxy resin was changed to 7.0 mass %.

### Comparative Example 5

In Comparative Example 5, with respect to Example 6, the amount of the iron powder was changed to Fe3.5Si4.5Cr.

For each of Examples 1 to 8 and Comparative Examples 1 to 5 described above, each of the following items were measured: density, inductance retention rate, relative permeability, radial crushing strength, and volume resistivity. The measurement method for each evaluation item was as follows. Note that, in the measurement of the inductance retention rate, the relative permeability, and the volume resistivity, a winding wire was wound around the magnetic core so that the inductance was 10 pH.

The “density” means the relative density of the test piece after the epoxy resin is cured. The density was measured in conformity with JIS Z 8807:2012.

The “inductance retention rate” is calculated by measuring an inductance value with an LCR meter when currents at 5 kHz and 1,000 kHz are each made to flow. Assuming that the value of the inductance at 5 kHz is 100%, the rate (%) of the value of the inductance when the current at 1,000 kHz is made to flow is the “inductance retention rate”. As the inductance retention rate is lower, the frequency characteristics in the high frequency range is lower.

The “relative permeability” was measured by measuring initial permeability at 5 kHz using an LCR meter (5 kHz, 10 mA, constant current mode) by an initial permeability measurement method in conformity with JIS C 2560-2:2006 when a winding wire was wound around a ring-shaped magnetic core of φ 20.2×φ12.6×t6 (mm) so that an inductance of 10 pH was obtained. As described above, for a magnetic core for an induction hardening apparatus used in a high frequency range of 100 KHz or more, it is desirable to achieve a relative permeability of 25 or less. The “inductance retention rate” was measured by performing a measurement from 5 kHz to 1,000 kHz using an LCR meter (5 kHz, 10 mA, constant current mode) by an initial permeability measurement method in conformity with JIS C 2560-2:2006 when a winding wire was wound around a ring-shaped magnetic core of φ20.2×φ12.6×t6 (mm) so that an inductance of 10 pH was obtained.

The “volume resistivity” was measured in conformity with a measurement method specified in JIS K 6911. As the volume resistivity is smaller, the eddy-current loss is larger and the heat loss in a high frequency range is larger; therefore, the volume resistivity is required to have as large a value as possible. The “radial crushing strength” was measured in conformity with the provision of JIS Z 2507:2000.

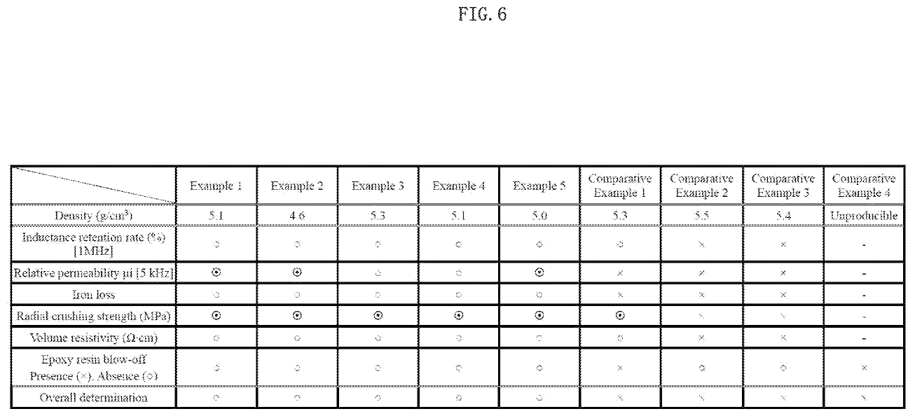

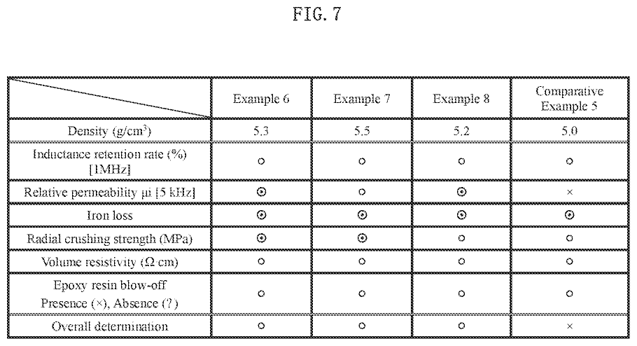

The test results are shown in FIGS. 4 to 7. FIGS. 4 and 5 show actual measurement values of each evaluation item, and FIGS. 6 and 7 show determination results of each evaluation item. In FIGS. 6 and 7, the inductance retention rate of 80% or more was determined as “∘”, and the inductance retention rate of less than 80% was determined as “×”. The relative permeability of 19 or more and less than 23 was determined as “⊚”, the relative permeability of 17 or more and less than 19 or 23 or more and 25 or less was determined as “∘”, and the relative permeabilities other than the above were determined as “×”. The radial crushing strength exceeding 61 was determined as “⊚”, the radial crushing strength of 50 or more and 60 or less was determined as “∘”, and the radial crushing strength of less than 50 was determined as “×”. As for the volume resistivity, 10⁶ order or more was determined as “0”, 10⁴ order to 10⁵ order was determined as “∘”, 10³ order was determined as “Δ”, and 102 or less was determined as “×”. As for an overall determination, a sample having been determined as “×” for even one item was determined as “×”, and the other samples were determined as “∘”.

From the comparison of the respective ones of the measurement results of Example 1, Examples 4 to 8, and Comparative Examples 1 to 4, it can be understood that when a magnetic core is produced from the following magnetic core material, it is possible to obtain a magnetic core for an induction hardening apparatus that has low permeability (25 or less), and at the same time, that has excellent frequency characteristics (large inductance retention rate) and satisfies required radial crushing strength and volume resistivity. The magnetic core material that contains: an Fe-based soft magnetic powder in which an inorganic insulating film is formed on the surface of Fe-based soft magnetic particles; and an epoxy resin material including a curing agent and an epoxy resin, wherein the Fe-based soft magnetic particles are a pure iron powder or a low-alloy steel powder, the content of the epoxy resin material is 2 mass % or more and 5 mass % or less, and the epoxy resin includes a bisphenol A-type epoxy resin and a novolac-type epoxy resin. In addition, since the epoxy resin is not blown off at the time of thermal curing, it is possible to avoid concerns about deterioration in productivity, occurrence of deviation of relative permeability of the molded body from a target value, and occurrence of deterioration in insulation and strength.

In contrast, in Comparative Example 1, in which a novolac-type epoxy resin was not used, the epoxy resin was blown off Therefore, it was found that the dimensional accuracy of the molded body was lowered and that the relative permeability showed a value of 30, which exceeded the target value. In Comparative Example 2, in which the epoxy resin was not used, the following fact was found. The relative permeability exceeded the target value, the strength was lower than the target value. and the volume resistivity was also lower than the target value. In Comparative Example 3, in which the amount of the epoxy resin was less than the above lower limit value, the following fact was found. As compared with the target values, the relative permeability was high, the strength was low, and the volume resistivity was also decreased. In Comparative Example 4, in which the amount of the epoxy resin was more than the above upper limit value, it was found that the epoxy resin was blown off and production of an evaluation sample itself was therefore impossible.

In addition, from the comparison of the respective ones of the measurement results of Examples 6 to 8 and Comparative Example 5, it has become clear that when a low-alloy steel powder was used as the Fe-based soft magnetic particles, the relative permeability exceeded the target value when the content of the alloy component exceeded 6.5 mass %.

### REFERENCE SIGNS LIST

1 Magnetic core
2 Coil
3 Current
4 Composite soft magnetic powder
4a Fe-based soft magnetic particle
4b Inorganic insulating film

1. A magnetic core material comprising:
an Fe-based soft magnetic powder in which an inorganic insulating film is provided on surfaces of Fe-based soft magnetic particles;
an epoxy resin material; and
a solid lubricant,
wherein the epoxy resin material includes a curing agent and an epoxy resin,
the Fe-based soft magnetic particles are a pure iron powder or a low-alloy steel powder,
a content of the epoxy resin material is 2 mass % or more and 5 mass % or less, and
the epoxy resin includes a bisphenol A-type epoxy resin and a novolac-type epoxy resin.

2. The magnetic core material according to claim 1, wherein the Fe-based soft magnetic particles are a low-alloy steel powder,
the low-alloy steel powder includes one or both of Si and Cr as an alloy component, and
a total content of the alloy component in the low-alloy steel powder is 6.5 mass % or less.

3. The magnetic core material according to claim 1, wherein the Fe-based soft magnetic particles are a pure iron powder, and
a content of the epoxy resin material is 3 mass % or more and 5 mass % or less.

4. The magnetic core material according to claim 1, wherein a median diameter D50 of the Fe-based soft magnetic powder is 10 μm or more and 70 μm or less.

5. A magnetic core comprising the magnetic core material according to claim 1, wherein the epoxy resin of the magnetic core material is cured.

6. The magnetic core according to claim 5, wherein a relative permeability of the magnetic core is 17 to 25.

7. The magnetic core according to claim 5 or 6, wherein the magnetic core has a radial crushing strength of 50 MPa or more.

8. The magnetic core according to claim 5, wherein the magnetic core has a volume resistivity of 1×10⁴ Ωcm or more.

9. The magnetic core according to claim 5, wherein an inductance retention rate of the magnetic core at 1,000 kHz with respect to 5 kHz is 80% or more.

10. The magnetic core according to claim 5, wherein the magnet core is disposed in combination with a coil of an induction heating apparatus.
